(19) United States
(12) Patent Application Publication
(10) Pub. No.: US 2026/0323540 A1
(43) Pub. Date: Oct. 15, 2026

(54) MAXIMUM TRANSMIT POWER AND EXPANDED BANDWIDTH CAPABILITY PARAMETERS INDICATION FOR DYNAMIC BANDWIDTH EXPANSION

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(73) Assignee: Cisco Technology, Inc., San Jose, CA (US)

(21) Appl. No.: 19/644,790

(22) Filed: Apr. 10, 2026

Related U.S. Application Data
(60) Provisional application No. 63/786,767, filed on Apr. 10, 2025.
(60) Provisional application No. 63/793,867, filed on Apr. 24, 2025.
(60) Provisional application No. 63/845,186, filed on Jul. 16, 2025.
(60) Provisional application No. 63/879,787, filed on Sep. 11, 2025.
(60) Provisional application No. 63/898,304, filed on Oct. 13, 2025.
(60) Provisional application No. 63/954,217, filed on Jan. 5, 2026.

(51) Int. Cl. H04W 52/36; H04L 1/00

(52) U.S. Cl. CPC H04W 52/367; H04L 1/0003

(57) ABSTRACT

Maximum transmit power and expanded bandwidth capability parameters indication for dynamic bandwidth expansion (DBE) and, specifically, transmit power indication and Modulation and Coding Scheme (MCS) and Number of Spatial Streams (NSS) parameters indication for DBE may be provided. An AP transmits beacon frames for a basic service set (BSS) operating at a first bandwidth (BW), the beacon frames including one or more transmit power envelope (TPE) elements providing maximum transmit power information for operation over the first BW. The AP transmits a DBE announcement indicating a BW expansion for the BSS to operate at an expanded DBE BW greater than the first BW. The DBE announcement comprises one or more DBE TPE elements providing maximum transmit power information for operation over the expanded DBE BW.

### RELATED APPLICATIONS

Under provisions of 35 U.S.C. § 119(e), Applicant claims the benefit of and priority to U.S. Provisional Application No. 63/786,767, filed Apr. 10, 2025; U.S. Provisional Application No. 63/793,867, filed Apr. 24, 2025; U.S. Provisional Application No. 63/845,186, filed Jul. 16, 2025; U.S. Provisional Application No. 63/879,787, filed Sep. 11, 2025; U.S. Provisional Application No. 63/898,304, filed Oct. 13, 2025; and U.S. Provisional Application No. 63/954,217, filed Jan. 5, 2026, the disclosures of which are incorporated herein by reference in their entirety.

### TECHNICAL FIELD

The present disclosure relates generally to providing maximum transmit power and expanded bandwidth capability parameters indication for dynamic bandwidth expansion (DBE) and, specifically, to providing transmit power indication and Modulation and Coding Scheme and Number of Spatial Streams parameters indication for DBE.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for transmit power indication and Modulation and Coding Scheme (MCS) and Number of Spatial Streams (NSS) parameters indication for Dynamic Bandwidth Expansion (DBE) in accordance with aspects of the present disclosure.

FIG. 2 illustrates an example Supported MCS and NSS Set field in accordance with aspects of the present disclosure.

FIG. 3 illustrates an example UHR Capabilities element in accordance with aspects of the present disclosure.

FIG. 4A illustrates an example Transmit Power Envelope (TPE) element with a first Maximum Transmit Power field format in accordance with aspects of the present disclosure.

FIG. 4B illustrates an example TPE element with a second Maximum Transmit Power field format in accordance with aspects of the present disclosure.

FIG. 5 illustrates an example Channel Switch Wrapper element in accordance with aspects of the present disclosure.

FIG. 6 illustrates an example DBE Operation Parameters field in accordance with aspects of the present disclosure.

FIG. 7 illustrates an example Ultra High Reliability (UHR) Operation element in accordance with aspects of the present disclosure.

FIG. 8 illustrates an example UHR Parameters Update element in accordance with aspects of the present disclosure.

FIG. 9 illustrates an example UHR Parameters Update element indicating the presence of a TPE Wrapper element in accordance with aspects of the present disclosure.

FIG. 10 illustrates an example TPE Wrapper element in accordance with aspects of the present disclosure.

FIG. 11 is a flow diagram illustrating a method for transmit power indication and MCS and NSS parameters indication for DBE in accordance with aspects of the present disclosure.

FIG. 12 is a block diagram of a computing device in accordance with aspects of the present disclosure.

FIG. 13 is a block diagram of a communications device in accordance with aspects of the present disclosure.

### DETAILED DESCRIPTION

### Overview

Maximum transmit power and expanded bandwidth indication for dynamic bandwidth expansion (DBE) and, specifically, transmit power indication and Modulation and Coding Scheme (MCS) and Number of Spatial Streams (NSS) parameters indication for DBE may be provided. An AP transmits beacon frames for a basic service set (BSS) operating at a first bandwidth (BW), the beacon frames including one or more transmit power envelope (TPE) elements providing maximum transmit power information for operation over the first BW. The AP transmits a DBE announcement indicating a BW expansion for the BSS to operate at an expanded DBE BW greater than the first BW. The DBE announcement comprises one or more DBE TPE elements providing maximum transmit power information for operation over the expanded DBE BW.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bn wireless networking standard (i.e., Wi-Fi 8) defines a Dynamic Bandwidth Expansion (DBE) feature that is currently being developed. DBE is a mode of operation that allows an Ultra-High Reliability (UHR) Access Point (AP) to widen the bandwidth (BW) of its Basic Service Set (BSS) for modern clients (e.g., UHR Stations (STAs) or Wi-Fi 8 clients) without disrupting legacy clients. The DBE operation enables a UHR AP to dynamically modify (e.g., expand, change, or reset) its operating BW for UHR STAs that support DBE operation. When operating in DBE mode with an expanded BW, the UHR AP continues to serve STAs that do not support DBE operation within the narrower baseline BSS BW.

DBE can be utilized to manage the load of APs in dense deployment scenarios. For example, in a network with four neighboring APs each operating on different 40 MHz channels, three APs may have a relatively light load while one AP is more heavily loaded. The more heavily loaded AP can perform DBE to expand to a wider BW (e.g., 80 MHz, 160 MHz, 320 MHz, etc.) to manage the higher load while creating minimal disruption to the other APs and their respective BSSs.

An AP can announce a dynamic BW change (expand, change, or reset) using a BSS parameters critical update mechanism in management frames, including Beacon, Probe Response, and (Re)Association Response frames. The dynamic BW change includes enabling DBE mode itself with an expanded DBE BW (e.g., expanding from the baseline BSS BW of 40 MHz to a DBE BW of 160 MHz), and the AP may later update the DBE BW to a different value (e.g., changing from a DBE BW of 160 MHz to a DBE BW of 320 MHz). The AP can also disable DBE mode, which can be considered as resetting the DBE BW to the baseline BSS BW. The dynamic BW change is typically announced for multiple beacon intervals in advance before the BW change takes effect. After a dynamic BW change, the AP may continue operating with the updated DBE BW until a subsequent BW change occurs. While an AP is operating in DBE mode, any expanded operating BW will be greater than the baseline BSS BW.

The Supported Modulation and Coding Schemes (MCS) and Number of Spatial Streams (NSS) Set advertises an AP's or STA's capabilities regarding the MCS and NSS it can support for one or more operating BWs. The Supported MCS and NSS Set is defined across Wi-Fi generations and includes, for example, Extremely High Throughput (EHT)-MCS Maps for operation at less than or equal to 80 MHz, 160 MHz, and 320 MHz bandwidths.

The Transmit Power Envelope (TPE) element or subelement conveys the local or regulatory maximum transmit power limits for various transmission BWs or channels within the BW of the BSS. STAs use the TPE element to ensure their transmissions do not exceed applicable maximum transmit power constraints, which is particularly important for operation in the 6 GHz band where regulatory and local power limits apply. The TPE element supports two types of power limit signaling: Equivalent Isotropically Radiated Power (EIRP)-based limits, which specify a maximum transmit power for a given PPDU BW (e.g., 20, 40, 80, 160, or 320 MHz); and EIRP Power Spectral Density (PSD)-based limits, which specify a maximum transmit PSD value for each 20 MHz sub-channel within the BSS BW. An AP may include multiple TPE elements in a beacon frame to cover different combinations of Maximum Transmit Power Interpretation and Maximum Transmit Power Category. The TPE element was extended for EHT (Wi-Fi 7) to include an Extension Maximum Transmit Power field covering 320 MHz operation. Per the baseline IEEE 802.11 specification, for channel switch operations, TPE information for the new channel is provided in a Channel Switch Wrapper element using one or more New TPE elements having the same format as the TPE element.

When an AP is operating at the baseline BSS BW or otherwise operating at a lower BW (e.g., 40 MHz), the AP may only indicate the BSS parameters needed for that BW. For example, the AP indicates Supported MCS and NSS Set parameters and TPE information for 40 MHz only. However, when the DBE BW is expanded by an AP, the non-AP STAs need to be provided with the BSS parameters for the expanded BW (and potential intermediate BWs). For example, if the BW is dynamically expanded from 40 MHz to 320 MHz, the non-AP STAs need to be provided with the Supported MCS and NSS Set parameters for 160 MHz and 320 MHz BWs, as well as the TPE information for the entire expanded 320 MHz DBE BW. When DBE is supported by an AP, then the AP needs to signal its maximum supported BW for DBE and then can provide Supported MCS and NSS Set parameters for supported DBE bandwidths. For example, if AP supports 320 MHz for DBE, then AP would signal 320 MHz as the maximum supported bandwidth for DBE and then would signal Supported MCS and NSS Set parameters for 160 MHz and 320 MHz DBE bandwidths.

A further concern arises from beacon bloating. Because reducing beacon size is a design goal for UHR, always including TPE information for the maximum DBE BW in the beacon, even when DBE mode is not enabled, is undesirable. For example, for a scenario where the BSS BW is 40 MHz and the maximum DBE BW is 320 MHz, always including TPE information for the DBE BW across four TPE elements (for Local EIRP, Regulatory client EIRP, Local EIRP PSD, and Regulatory client EIRP PSD interpretations) would add approximately 36 octets of additional overhead to each beacon, and up to 72 octets of additional overhead to each beacon if TPE elements for both Maximum Transmit Power Category values are included. Additionally, modifying the existing TPE elements in beacon frames to cover the expanded DBE BW raises legacy interoperability concerns, as legacy STAs have not been tested with frequent changes to information in TPE elements or with TPE information covering BWs greater than the BSS BW. Similarly, for the Supported MCS and NSS Set, an AP operating at a baseline BSS BW of 40 MHz or 80 MHz may not advertise MCS and NSS capabilities for 160 MHz or 320 MHz BWs in existing legacy capability fields, because doing so could cause legacy STAs that are unaware of DBE to misinterpret the AP's capabilities and potentially disassociate in search of a different AP.

Embodiments described herein address these gaps by providing procedures and signaling mechanisms for indicating the maximum supported DBE bandwidth, Supported MCS and NSS Set parameters for supported DBE bandwidths and the TPE for an expanded DBE BW, while minimizing beacon overhead and avoiding legacy interoperability issues.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

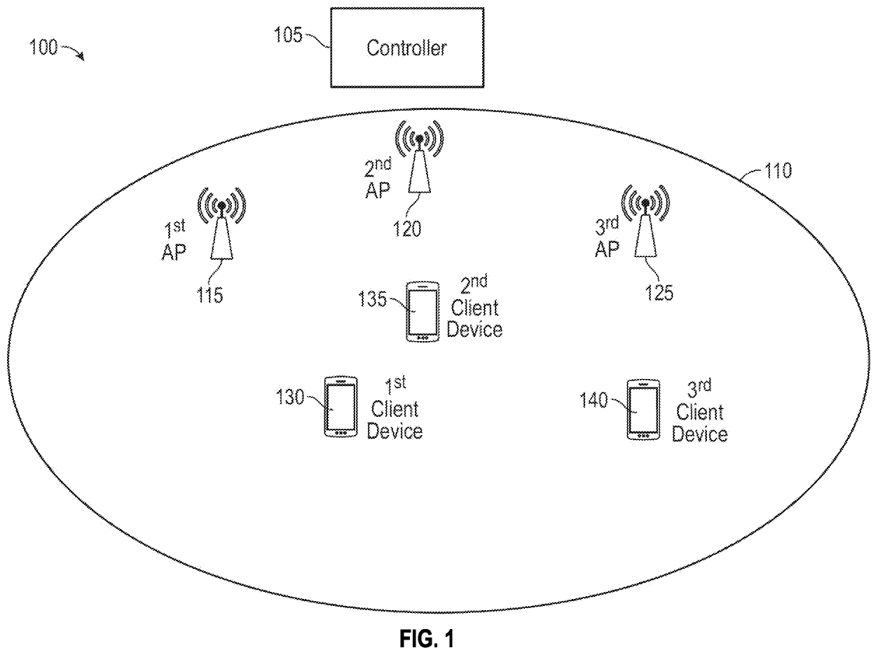

FIG. 1 illustrates an example operating environment 100 for performing TPE and Supported MCS and NSS Set signaling for DBE operation. As shown in FIG. 1, operating environment 100 comprises a controller 105 and a coverage environment 110. Coverage environment 110 comprises a Wireless Local Area Network (WLAN) comprising a plurality of Access Points (APs) that provide wireless network access for client devices. The APs comprise a first AP 115, a second AP 120, and a third AP 125 in the illustrated embodiment. As described below, the plurality of APs can comprise any number of APs in further embodiments.

The APs provide wireless network access to client devices (i.e., STAs) as they move within coverage environment 110. The client devices comprise a first client device 130, a second client device 135, and a third client device 140. The client devices may be any device that can wirelessly connect to the network, such as a smart phone, a personal computer, a tablet device, a mobile device, a telephone, a remote control device, a set-top box, a digital video recorder, an Internet-of-Things (IoT) device, a network computer, a router, a Virtual Reality (VR)/Augmented Reality (AR) device, or other similar microcomputer-based device. Each of the plurality of APs may be compatible with specification standards such as the IEEE 802.11 specification standard, including the IEEE 802.11bn (Wi-Fi 8) standard that supports DBE operation.

The APs and the client devices may use Multi-Link Operation (MLO) where they simultaneously transmit and receive across different bands or links and channels by establishing two or more links to two or more AP radios in certain embodiments. These bands may comprise the 2.4 GHz band, the 5 GHz band, the 6 GHz band, and the 60 GHz band. The two or more links on any given one of the plurality of client devices may be made with any one AP or with any combination of the APs. The 6 GHz band is particularly relevant to DBE operation, as client devices operating in the 6 GHz band are required to follow regulatory and local maximum transmit power constraints, which the AP communicates via the TPE element. The maximum transmit power constraints to be followed by clients can also be provided for DBE operation (using TPE elements) for other bands such as 5 GHz, 2.4 GHz, and 60 GHz bands.

Controller 105 comprises a WLAN controller and may provision and control coverage environment 110 (e.g., the WLAN). Controller 105 may allow first client device 130, second client device 135, and third client device 140 to join coverage environment 110. In some embodiments, controller 105 may be implemented by a Digital Network Architecture Center (DNAC) controller (i.e., a Software-Defined Network (SDN) controller) that configures information for coverage environment 110 to facilitate DBE operation. In some embodiments, controller 105 or another component in operating environment 100 may include a Radio Resource Management (RRM) function that configures information for coverage environment 110 to optimize wireless performance, including managing DBE operation and bandwidth expansion decisions.

Each of the APs (e.g., first AP 115, second AP 120, third AP 125) can perform DBE operation. For DBE operation, an AP can dynamically widen its operating BW to an expanded DBE BW for client devices that support DBE (e.g., UHR STAs or Wi-Fi 8 clients) while continuing to serve legacy client devices within the baseline BSS BW. For example, an AP operating on a baseline BSS BW of 40 MHz may expand to a DBE BW of 160 MHz or 320 MHz when managing higher traffic loads and/or when neighboring APs are lightly loaded. When a DBE-capable AP (a DBE AP) enables or updates the DBE BW, it announces the BW change in advance using a BSS parameters enhanced critical update (critical updates) mechanism, which is carried in management frames such as beacon, probe response, and (Re)Association Response frames.

As described in detail below with respect to the remaining figures, the embodiments described herein provide procedures and signaling mechanisms for two related aspects of DBE operation. First, for DBE operation the AP must indicate the maximum supported bandwidth for DBE and indicate Supported MCS and NSS Set for the supported DBE bandwidths. (For example, indicate that the maximum supported bandwidth for DBE is 320 MHz and indicate the EHT-MCS Map for 160 MHz and/or 320 MHz to DBE-capable non-AP STAs, which may be accomplished via DBE-specific capability fields to avoid legacy interoperability issues. Second, the AP must provide TPE information for the expanded DBE BW so that DBE-capable non-AP STAs can follow applicable regulatory and local maximum transmit power constraints when operating over the expanded BW. To minimize beacon overhead and avoid legacy compatibility issues, the TPE information for the DBE BW is provided as part of the DBE critical updates announcement (e.g., within a DBE TPE element or element included in the Mode Specific Parameters field for DBE in the UHR Parameters Update element, or in the DBE Operation Parameters field of the UHR Operation element), rather than by modifying the existing TPE elements carried in beacon and probe response frames which are also interpreted by legacy clients. Changes to TPE information for the DBE BW while DBE mode is active are similarly signaled using the DBE parameter critical update procedure.

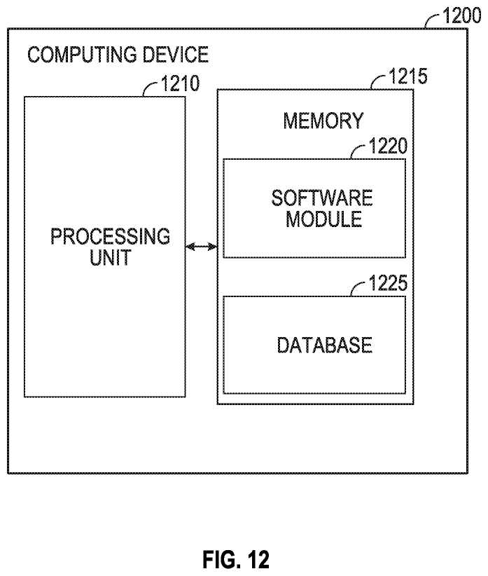

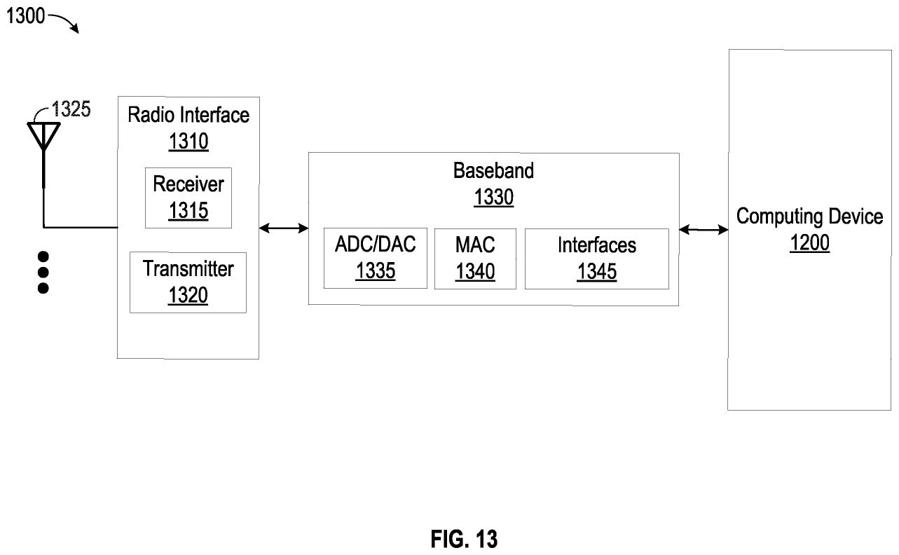

The elements described above of the operating environment 100 (e.g., the controller 105, the first AP 115, the second AP 120, the third AP 125, the first client device 130, the second client device 135, the third client device 140, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 12 and 13, the elements of the operating environment 100 may be practiced in a computing device 1200 and/or communications device 1300.

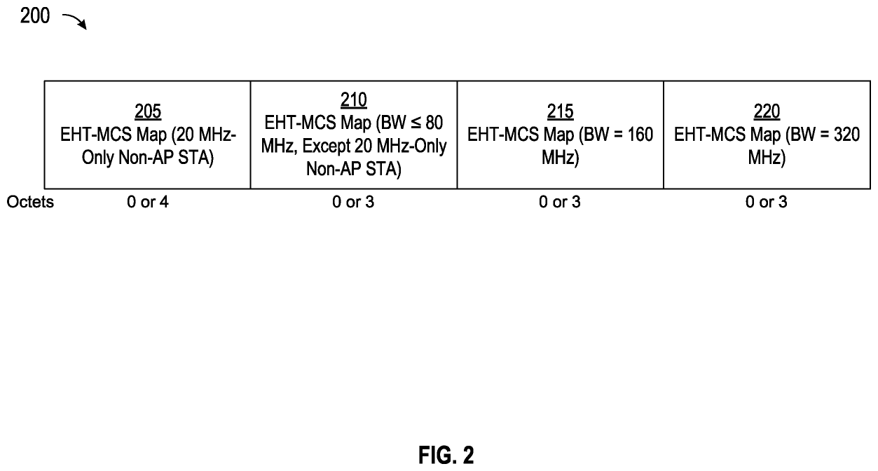

FIG. 2 illustrates a Supported MCS and NSS Set field 200, such as a Supported EHT-MCS And NSS Set field. APs can transmit the Supported MCS and NSS Set field 200 in Beacon frames, Probe Response frames, and (Re)Association Response frames. The Supported MCS and NSS Set field 200 includes an EHT-MCS Map (20 MHz-Only Non-AP STA) field 205, an EHT-MCS Map (BW≤80 MHz, Except 20 MHz-Only Non-AP STA) field 210, an EHT-MCS Map (BW=160 MHz) field 215, and an EHT-MCS Map (BW=320 MHz) field 220. The EHT-MCS Map (BW≤80 MHz, Except 20 MHz-Only Non-AP STA) field 210, the EHT-MCS Map (BW=160 MHz) field 215, and the EHT-MCS Map (BW=320 MHz) field 220 are optional fields that are each three octets in length when included in the Supported MCS and NSS Set field 200.

The EHT-MCS Map (20 MHz-Only Non-AP STA) field 205 indicates the supported MCS and NSS parameters for STAs with operating BW of 20 MHz. The EHT-MCS Map (BW≤80 MHz, Except 20 MHz-Only Non-AP STA) field 210 indicates the supported MCS and NSS parameters for an operating BW at or below 80 MHz, except for the STAs with operating BW of 20 MHz. The EHT-MCS Map (BW=160 MHz) field 215 indicates the supported MCS and NSS parameters for an operating BW of 160 MHz. The EHT-MCS Map (BW=320 MHz) field 220 indicates the supported MCS and NSS parameters for an operating BW of 320 MHz.

The Supported MCS and NSS Set field 200 can include zero or more of the optional fields depending on which BWs the AP wants to provide supported MCS and NSS parameters for. The following describes several approaches for providing the Supported MCS and NSS Set for DBE expanded BWs (i.e. the bandwidths that are supported for DBE operation).

### Indicating Supported MCS and NSS Set for DBE BWs Using Existing Capability Fields when DBE is Enabled

In one embodiment, when an AP has the DBE feature enabled and the maximum DBE BW it supports is 160 MHz, the AP sets a bit (e.g., the B2 bit) of the Supported Channel Width Set field in the HE PHY Capabilities Information field of the frame to 1 and includes the EHT-MCS Map (BW=160 MHz) field 215 in the Supported MCS And NSS Set field 200 of the EHT Capabilities element of the frame.

If the maximum DBE BW the AP supports is 320 MHz, the AP sets the bit (e.g., the B2 bit) of the Supported Channel Width Set field in the HE PHY Capabilities Information field of the frame to 1, includes the EHT-MCS Map (BW=160 MHz) field 215 in the Supported MCS And NSS Set field 200 of the EHT Capabilities element of the frame, sets the Support For 320 MHz In The 6 GHz subfield of the EHT PHY Capabilities Information field to 1, and includes the EHT-MCS Map (BW=320 MHz) field 220 in the Supported MCS And NSS Set field 200 of the EHT Capabilities element of the frame. Providing the EHT-MCS Map (BW ≤80 MHz, Except 20 MHz-Only Non-AP STA) field 210 is required in certain embodiments.

Enabling the DBE feature does not necessarily require the DBE BW to be expanded. An AP that enables the DBE feature can later activate the DBE BW expansion using the DBE bandwidth update procedure.

Since the optional fields (the EHT-MCS Map (BW≤80 MHz, Except 20 MHz-Only Non-AP STA) field 210, the EHT-MCS Map (BW=160 MHz) field 215, and the EHT-MCS Map (BW=320 MHz) field 220) are each 3 octets, the overhead in Beacon frames is minimal for an AP to always include the EHT-MCS Map (BW=160 MHz) field 215 and the EHT-MCS Map (BW=320 MHz) field 220 for 160 MHz and 320 MHz whenever the DBE feature is enabled. This approach provides simple logic for an AP to provide the Supported MCS and NSS Set for 160 MHz and 320 MHz.

Similarly, if a non-AP STA supports DBE-expanded BWs of 80 MHz, 160 MHz, and/or 320 MHz, the non-AP STA can set the appropriate existing capability fields (e.g., the Supported Channel Width Set field bits and the Support For 320 MHz in the 6 GHz subfield) to indicate support for 80 MHz, 160 MHz, and/or 320 MHz BWs, and include the corresponding EHT-MCS Map fields (e.g., the EHT-MCS Map (BW≤80 MHz, Except 20 MHz-Only Non-AP STA) field 210, the EHT-MCS Map (BW=160 MHz) field 215, and the EHT-MCS Map (BW=320 MHz) field 220) in the Supported MCS And NSS Set field 200 to indicate what the non-AP STA supports to the AP. Because this information is exchanged during the (Re)Association Request/Response, there is no concern over the additional overhead of up to 9 octets. When the DBE BW is later expanded to 80 MHz, 160 MHz, or 320 MHz, both the non-AP STA and the AP will already have the Supported EHT-MCS And NSS Set information for those BWs.

In some embodiments, the AP does not have the DBE feature enabled initially. In this case, the AP may not provide the Supported EHT-MCS And NSS Set for 160 MHz and 320 MHz BWs (e.g., via the EHT-MCS Map (BW=160 MHz) field 215 and the EHT-MCS Map (BW=320 MHz) field 220). When the AP later enables the DBE feature, the AP indicates the maximum DBE BW supported in the UHR Capabilities element and indicates support for 160 MHz and/or 320 MHz BWs using the existing capability fields described above, and includes the EHT-MCS Map (BW=160 MHz) field 215 and the EHT-MCS Map (BW=320 MHz) field 220 in the Supported MCS And NSS Set field 200. Similarly, non-AP STAs can indicate their support for DBE and their maximum supported DBE BW. Based on the maximum supported DBE BW (e.g., 80 MHz, 160 MHz, or 320 MHz), the non-AP STA can include the corresponding EHT-MCS Map fields (i.e., the EHT-MCS Map (BW≤80 MHz, Except 20 MHz-Only Non-AP STA) field 210, the EHT-MCS Map (BW=160 MHz) field 215, and/or the EHT-MCS Map (BW =320 MHz) field 220). When the DBE BW is expanded to 80 MHz, 160 MHz, or 320 MHz, both the non-AP STA and the AP will already have the Supported EHT-MCS And NSS Set information for those BWs.

### Including MCS and NSS Map Fields Only when the BW is Expanded

In other embodiments, because the EHT-MCS Map for 160 MHz and 320 MHz only applies after the BW has been expanded to 160 MHz or 320 MHz, the EHT-MCS Map (BW=160 MHz) field 215 and the EHT-MCS Map (BW=320 MHz) field 220 are included in the Supported MCS And NSS Set field 200 of the EHT or UHR Capabilities element only when the BW is actually expanded, rather than whenever the DBE feature is enabled. In this case, the AP also updates the capability bits indicating supported channel widths for 160 MHz and 320 MHz BWs only when the BW is expanded. Once the DBE BW expansion is reset to the BSS operating BW of 80 MHz or lower, the AP updates its capability bits to indicate that it does not support 160 MHz or 320 MHz BWs and does not include the EHT-MCS Map (BW=160 MHz) field 215 and the EHT-MCS Map (BW=320 MHz) field 220 in the Supported EHT-MCS And NSS Set field 200. Because this option causes more frequent changes to AP capability indications, it may be less preferred compared to providing TPE information with critical updates in certain implementations.

In some embodiments, even after the DBE BW is reset to the BSS BW, the AP continues to have the capability bits indicating support for 160 MHz and/or 320 MHz BWs set to 1, and continues to include the EHT-MCS Map (BW=160 MHz) field 215 and the EHT-MCS Map (BW=320 MHz) field 220 in the Supported MCS And NSS Set field 200. When the DBE BW is subsequently expanded again, the AP does not need to advertise any additional MCS and NSS parameter information for 160 MHz and/or 320 MHz.

### Indicating Supported MCS and NSS Set for DBE BWs Using DBE-Specific Capability Fields

In some embodiments, an AP may not advertise higher BW capability in existing fields and elements that can be understood by legacy STAs. This is because legacy STAs may observe an AP advertising capabilities for a much higher BW than the AP's operating BSS BW and, as a result, treat the AP as not a well-behaved AP and disassociate to look for other APs. To avoid such legacy interoperability impacts, a DBE-capable AP may not indicate higher BW capability in existing capability fields that are visible to legacy STAs. Instead, the AP indicates its higher BW capability for DBE only in DBE-related fields, subelements, or elements that are interpreted only by DBE-supporting STAs.

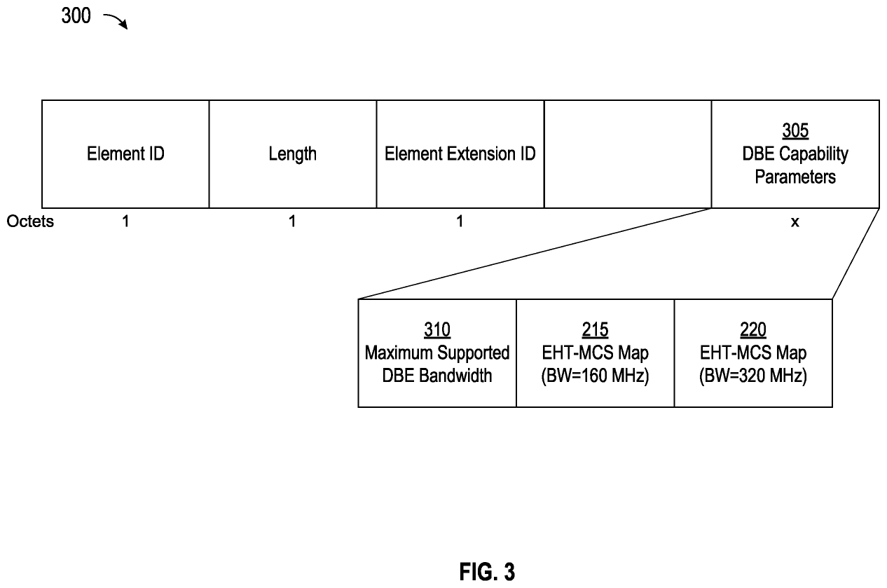

FIG. 3 illustrates an example UHR Capabilities element 300 comprising a DBE Capability Parameters field 305 for indicating DBE-specific parameters. The reporting AP can include the DBE Capability Parameters field 305 to provide DBE parameters, including the maximum supported DBE BW (e.g., 320 MHz) or a set of supported DBE BWs (e.g., 160 MHz and 320 MHz), and includes the EHT-MCS Map information for those supported DBE BWs in that DBE-specific field. For example, if the AP supports 320 MHz as maximum bandwidth for DBE, the maximum supported bandwidth field indicates 320 MHz. The AP may also indicate any other bandwidth as maximum supported BW for DBE (e.g. 160 MHz, 80 MHz or 40 MHz). In the illustrated embodiment, the DBE Capability Parameters field 305 includes a Maximum Supported DBE Bandwidth field 310 for indicating the maximum supported DBE BW or set of supported DBE BWs the reporting AP currently supports. The DBE Capability Parameters field 305 also includes an EHT-MCS Map (BW=160 MHz) field 215 and an EHT-MCS Map (BW=320 MHz) field 220.

In this approach, as part of its DBE-specific parameters indicated in the DBE Capability Parameters field 305, the AP includes the EHT-MCS Map fields for the BWs it supports for DBE (e.g., the EHT-MCS Map (BW=160 MHz) field 215 and/or the EHT-MCS Map (BW=320 MHz) field 220) only within the DBE-specific element, subelement, or field, rather than in the legacy Supported MCS And NSS Set field 200 of the EHT Capabilities element. For example, if the AP supports DBE for 160 MHz and 320 MHz, the AP includes the EHT-MCS Map (BW=160 MHz) field 215 and the EHT-MCS Map (BW=320 MHz) field 220 in this DBE-specific field. The AP can include the DBE-specific field in management frames where the UHR Capabilities element is included, such as Beacon frames, Probe Response frames, (Re)Association Response frames, BSS Transition Management Request frames, and Neighbor Report Response frames. When a DBE mode is enabled, the AP also includes the DBE Operation Parameters field in the UHR Operation element in Probe Response and (Re)Association Response frames, which provides the DBE BW field, the DBE Disabled Subchannel Bitmap field (if applicable), and the DBE TPE Elements field (if applicable). In some cases, the DBE Operation Parameters field in the UHR Operation element may also be included in beacon frames.

For a non-AP STA, legacy interoperability impact is less of a concern, and the non-AP STA can indicate its higher BW capability supported for DBE in existing BW capability fields such as in the bandwidth capabilities fields defined for VHT, HE and EHT. In this case, the maximum BW capability indicated by the non-AP STA in existing VHT, HE and EHT BW capability fields is considered to be the maximum bandwidth supported by that STA for DBE. Also, in some cases a non-AP STA may support a smaller maximum BW for DBE than its general maximum BW capability, the non-AP STA may separately signal its maximum supported DBE BW in DBE-specific fields, subelements, or elements. In one embodiment, a non-AP STA can also indicate its EHT-MCS Map fields for the BWs it supports for DBE (e.g., 80 MHz, 160 MHz, and/or 320 MHz) as part of the DBE-specific parameters, rather than in existing generic capability fields.

In the above embodiments, the Basic EHT-MCS And NSS Set field in the EHT or UHR Operation element need not change as a result of DBE operation.

### Providing TPE Information for DBE Expanded BW

For TPE information, an AP needs to provide TPE for the expanded BW after DBE BW expansion. There are two situations in which an AP needs to provide TPE information for the DBE BW. The first situation is the transition from non-DBE operation to DBE operation (i.e. enabling the DBE mode). In this case, the TPE information for the upcoming DBE BW is announced before the DBE mode enablement change takes effect, and TPE information for the expanded DBE BW is also reported after the change. The second situation is the transition from DBE operation at one DBE BW to DBE operation at a different DBE BW. In the second situation, the AP indicates the TPE information for the current DBE BW and the TPE information announcement for the upcoming new DBE BW before the change takes effect, and the AP reports the TPE information for the new DBE BW only after the change.

These two situations are addressed by, in one embodiment, enabling the AP to signal TPE(s) for the current DBE BW and separately signal TPE(s) for the upcoming DBE BW. In example implementations, both sets of TPE information use the same format, but one set (e.g., the announced or upcoming TPE(s)) is sent with extra encapsulation (e.g., in a “DBE Wrapper” or “DBE Announcement Wrapper” element or subelement) while the other set is not. In another embodiment, the AP always signals TPE(s) for the maximum DBE BW that the AP will use, or the maximum supported DBE BW. Where there is ambiguity (e.g., 320-1 or 320-2) and the AP is currently operating at a lower DBE BW, additional signaling resolves the ambiguity (e.g., indicating “these TPEs are for 320-1” or “these TPEs are for 320-2”). In some cases, the AP may signal TPEs for all possible options (i.e., both 320-1 and 320-2) with corresponding identification, via ordering or an extra field.

### Providing TPE Information in TPE Element

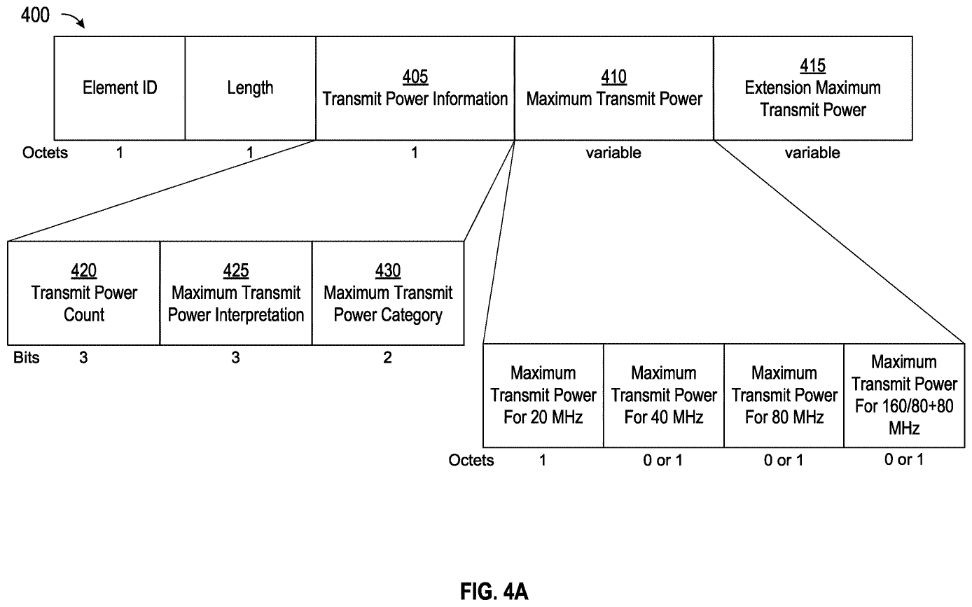

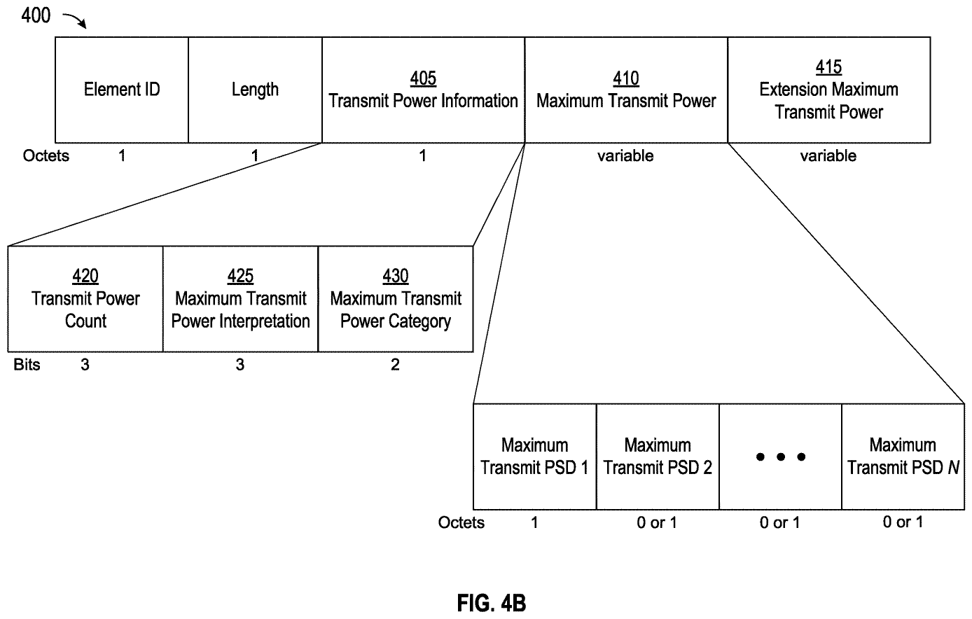

FIG. 4A illustrates an example TPE element 400 with a first Maximum Transmit Power field format. The TPE element 400 includes a Transmit Power Information field 405, a Maximum Transmit Power field 410, and an Extension Maximum Transmit Power field 415. The Transmit Power Information field 405 includes a Transmit Power Count field 420, a Maximum Transmit Power Interpretation field 425, and a Maximum Transmit Power Category field 430. The Maximum Transmit Power field 410 and the Extension Maximum Transmit Power field 415 provide the local or regulatory maximum transmit powers for various transmission BWs or channels within the BW of the BSS.

The Maximum Transmit Power field 410, in the first format, includes respective Maximum Transmit Power subfields indicating the maximum transmit power for 20 MHz, 40 MHz, 80 MHz, and 160/80+80 MHz physical layer protocol data unit (PPDU) BWs. The Maximum Transmit Power field 410 is in the first format when the Maximum Transmit Power Interpretation field 425 is set to 0 (Local EIRP), 2 (Regulatory client EIRP), or 4 (Additional regulatory client EIRP). Additionally, in the first format, he Extension Maximum Transmit Power field 415 indicates the maximum transmit power for the 320 MHz PPDU BW. One TPE element 400 is included in Beacon frames for each distinct combination of the Maximum Transmit Power Interpretation field 425 and the Maximum Transmit Power Category field 430. Multiple TPE elements can be included based on regulatory requirements.

FIG. 4B illustrates an example TPE element 400 with a second Maximum Transmit Power field format. In the second format, the Maximum Transmit Power field 410 includes Maximum Transmit PSD subfields fields for one or more operating BWs, indicating the PSD value for the respective BWs (e.g., for each 20 MHz sub-channel within the operating BW, from lowest to highest frequency). The Maximum Transmit Power field 410 is in the second format when the Maximum Transmit Power Interpretation field 425 is set to 1 (Local EIRP PSD), 3 (Regulatory client EIRP PSD), or 5 (Additional regulatory client EIRP PSD). Also, in the second format, the Extension Maximum Transmit Power field 315 indicates the maximum transmit power PSD values subchannels for 320 MHz BW. The TPE element 400 illustrated in FIG. 4B differs from the TPE element 400 in FIG. 4A only in the interpretation and structure of the Maximum Transmit Power field 410, and both elements use the same overall TPE element format.

Regarding size, for a 320 MHz BSS BW, an Effective Isotropic Radiated Power (EIRP)-based TPE element (Maximum Transmit Power Interpretation field 425=0, 2, or 4) is 8 octets in size. An EIRP PSD-based TPE element (Maximum Transmit Power Interpretation field 425=1, 3, or 5) for a 320 MHz BW is 20 octets in size. Given that multiple TPE elements may be included (both EIRP and EIRP PSD types, and for Maximum Transmit Power Category values 0 and 1), the overall TPE information size in a Beacon frame can become significant and contributes to beacon bloating. Therefore, adding TPE information for the DBE BW directly to the existing TPE elements carried in Beacon frames raises both beacon bloating and legacy interoperability concerns, as discussed in further detail below.

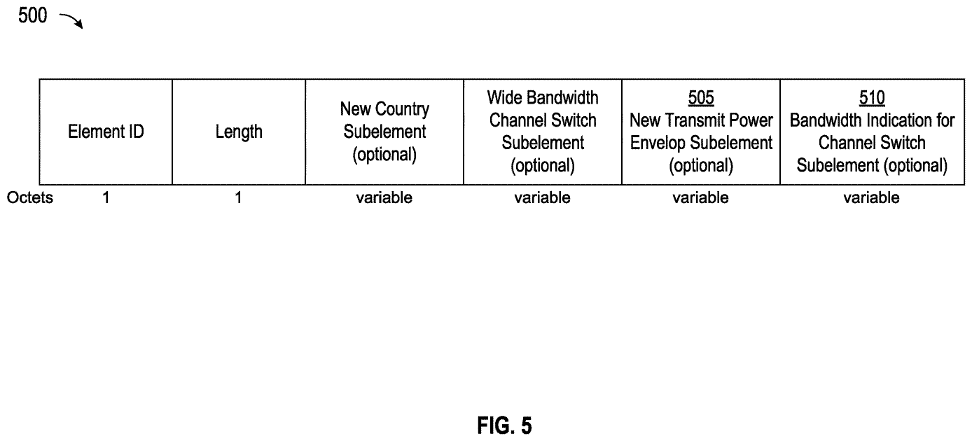

FIG. 5 illustrates an example Channel Switch Wrapper element 500 which is used by the AP when it performs a primary channel switch to a new primary channel. For a channel switch operation, the TPE information for the new channel is provided as part of the Channel Switch Wrapper element 500 using one or more New TPE elements 505 having the same content format as the TPE element 400. The Bandwidth Indication For Channel Switch subelement 510 indicates the operating BW for the channel to which the AP is switching. The DBE signaling embodiments described herein draw upon a similar approach, providing TPE information for the DBE BW within a DBE-specific encapsulation element or subelement rather than modifying the existing TPE elements in Beacon frames.

### Providing TPE Information as Part of DBE Critical Update Announcement

In some embodiments, TPE information for the DBE expanded BW is provided as part of the DBE Critical Update announcement. The TPE information for the DBE BW is provided in one or more DBE TPE elements (or a new field/element) as part of the DBE critical updates announcement. Each DBE TPE element may provide complete TPE information for the entire DBE BW, rather than only the delta relative to the BSS BW TPE elements (though the delta approach is possible as well). Because the TPE information for the DBE BW is carried only within the DBE critical updates notification, not in the general Beacon frame TPE elements, this approach minimizes beacon bloating impact and has no legacy STA compatibility impact, as the existing TPE elements in the Beacon frame are not modified. In one embodiment, the DBE TPE elements carried as part of the DBE Critical Update announcement may indicate TPE information only for additional portion of the DBE BW on top of the baseline BSS BW. In this case, the non-AP STA combines TPE information from the DBE TPE elements in the DBE Critical Update announcement and from the existing TPE elements from the beacon frames to determine the complete set of TPE information for the entire DBE BW.

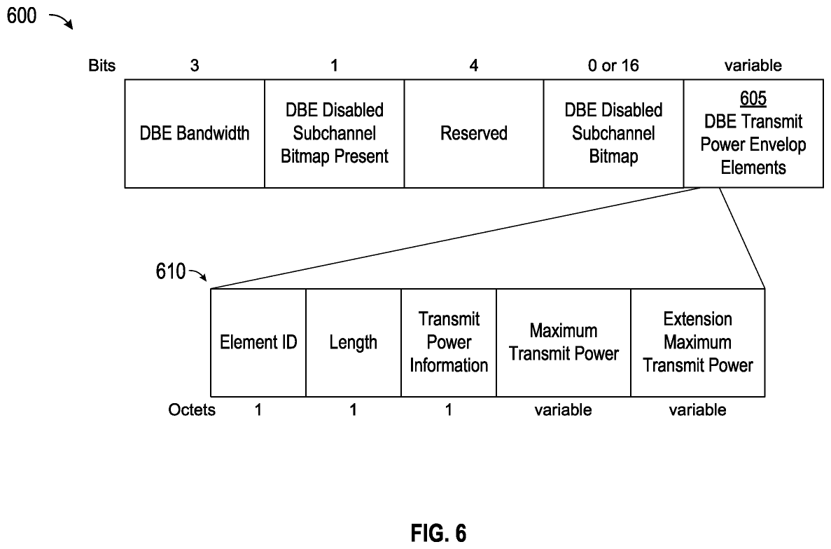

FIG. 6 illustrates an example DBE Operation Parameters field 600. The DBE Operation Parameters field 600 includes a DBE Bandwidth field (B0-B2), a DBE Disabled Subchannel Bitmap Present field (B3), a Reserved field (B4-B7), a DBE Disabled Subchannel Bitmap field (B8-B23, present when the DBE Disabled Subchannel Bitmap Present field is set to 1), and an optional DBE TPE Elements field 605. The DBE TPE Elements field 605 includes zero or more DBE TPE elements 610 and is included (with one or more DBE TPE elements 610) when the DBE expanded BW is being announced and TPE information needs to be provided for the DBE BW per regulatory or local rules. Each DBE TPE element 610 has the same format as the TPE element 400, except that if it is defined as a new field that is carried in the DBE Operation Parameters field 600. The DBE TPE element 610 provides the maximum transmit power allowed for operation over the entire expanded DBE BW (e.g., spanning 160 MHz or 320 MHz if the DBE expanded BW is 160 MHz or 320 MHz, respectively). The DBE TPE element 610 is skipped over by pre-UHR STAs, given its inclusion as a field/element within a DBE/UHR wrapper element.

The DBE TPE element(s) or element(s) can be carried in the following containers, depending on implementation. If the DBE BW expansion is announced using a Critical Parameters Update (Wrapper) (CPU(W)) element, then DBE TPE element(s) can be included in the CPU(W) element. If the DBE BW expansion is announced using a DBE Announcement/Wrapper element, then DBE TPE element(s) can be included in that element. After the DBE BW is expanded, the expanded DBE BW can be indicated in the UHR Operation element. In this case, DBE TPE element(s) (or its contents) can be included in the UHR Operation element. In one embodiment, after the DBE BW is expanded, the expanded DBE BW can be indicated in a separate DBE Operation Parameters element. In this case, DBE TPE element(s) can be included in the DBE Operation Parameters element. In all these cases, the DBE TPE elements included for the DBE BW will use the same element ID as defined for the TPE element, but is wrapped inside of another UHR or DBE element, which prevents legacy (or non-UHR STAs) from decoding and interpreting DBE TPE information avoiding legacy compatibility issue.

In one embodiment, the DBE BW expansion parameters are indicated in the Beacon frame only for a certain time duration (e.g., for the advance notification period for DBE critical update announcement), including the DBE TPE information for the DBE expanded BW. In this case, a non-AP MLD that was in a deep sleep state and missed receiving the DBE parameters from the Beacon frame will obtain the DBE TPE information using a Probe Request/Response exchange or another frame exchange.

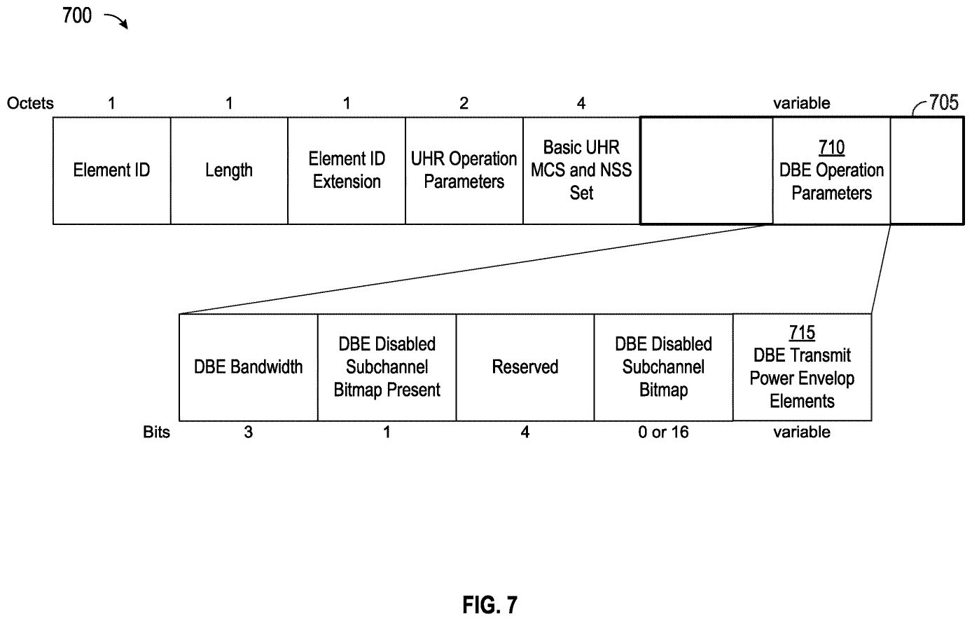

FIG. 7 illustrates an example UHR Operation element 700 including optional subfields 705. A DBE Operation Parameters field 710 is included in the optional subfields 705. The DBE Operation Parameters field 710 has the same structure as the DBE Operation Parameters field 600 illustrated in FIG. 6 and includes a DBE TPE Elements field 715 for including zero or more DBE TPE elements (e.g., having the same format as TPE element 400).

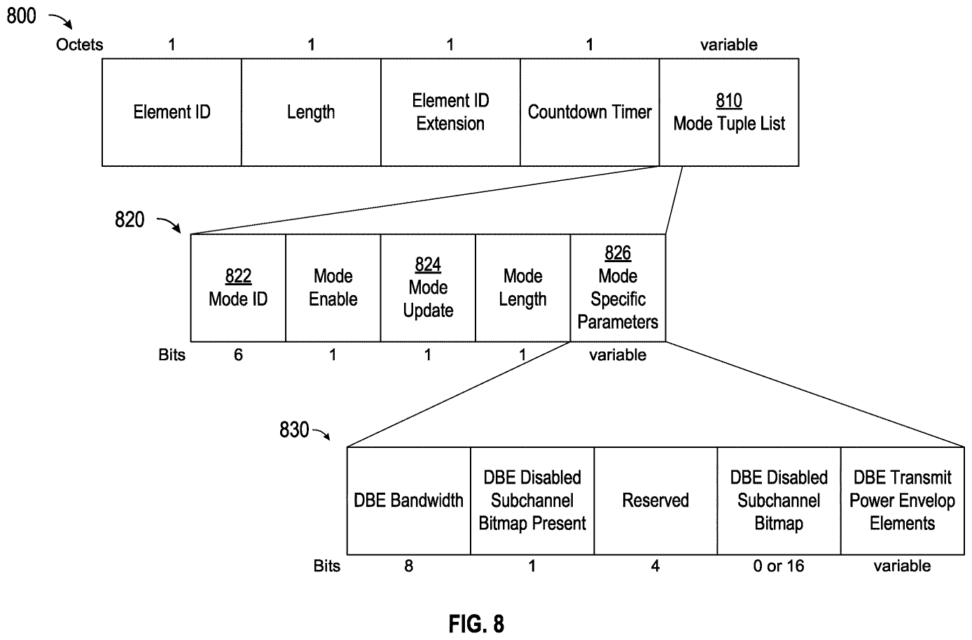

FIG. 8 illustrates an example UHR Parameters Update element 800. The UHR Parameters Update element 800 includes an Element ID field, a Length field, an Element ID Extension field, a Countdown Timer field, and a Mode Tuple List 820. The Mode Tuple List 820 includes one or more Mode Tuple fields, each comprising a Mode ID field 822, a Mode Enable field, a Mode Update field 824, a Mode Length field, and a Mode Specific Parameters field 826. The Mode ID field 822 indicates which mode the Mode Tuple is for (e.g., DBE). The Mode Specific Parameters field 826 for DBE includes the DBE Bandwidth field (B0-B2), the DBE Disabled Subchannel Bitmap field (B8-B23, when applicable), and the DBE TPE Elements field (variable, when applicable) containing zero or more DBE TPE elements 610. The optional presence of the DBE TPE Elements field may be signaled using a reserved bit in the Mode Specific Parameters field or may be inferred from the Mode Length field. The UHR Parameters Update element 800 is included in Beacon frames, Probe Response frames, and (Re)Association Response frames during the DBE critical updates advance notification period (and in some cases may be included in these frames post the DBE changes taking effect).

### Providing TPE Information in a Separate DBE TPE Wrapper Element

In another embodiment, the TPE information for the DBE expanded BW is provided in a separate DBE TPE Wrapper element, rather than being embedded within the DBE critical updates announcement itself. This approach is a variant of providing the TPE information in a critical update.

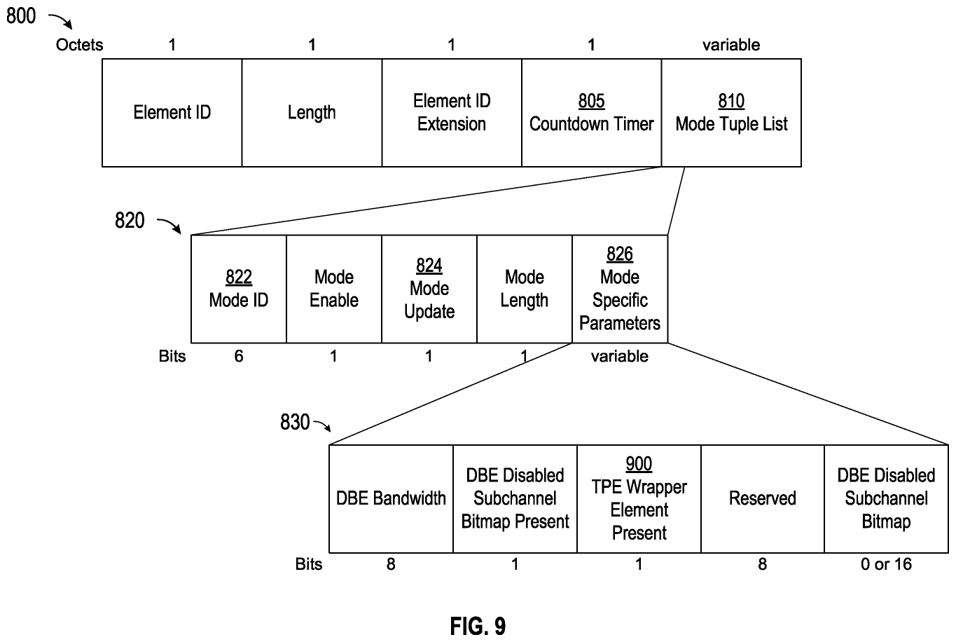

FIG. 9 illustrates the UHR Parameters Update element 800 with an additional TPE Wrapper Element Present field 900 within the Mode Specific Parameters field 826 for DBE. The TPE Wrapper Element Present field 900 uses a reserved bit of the Mode Specific Parameters field 826 and is set to 1 to indicate that a DBE TPE Wrapper element is present in the frame.

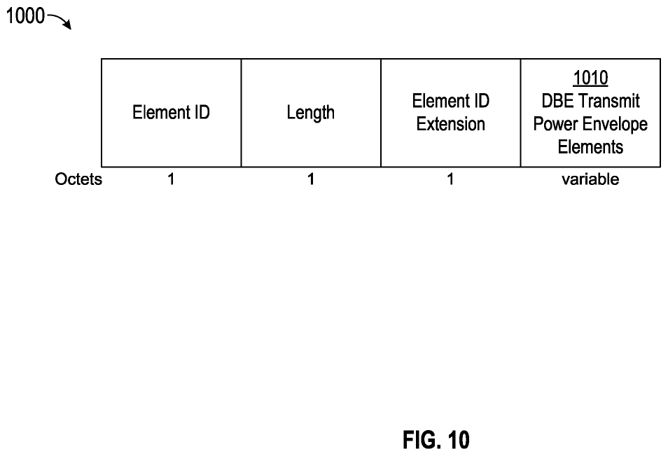

FIG. 10 illustrates an example TPE Wrapper Element 1000. The TPE Wrapper Element 1000 includes an Element ID field, a Length field, an Element ID Extension field, and a DBE TPE Elements field 1010 containing one or more DBE TPE elements (having the same format as the DBE TPE elements field 605 of FIG. 6). The TPE Wrapper Element 1000 is included in Beacon frames, Probe Response frames, and (Re)Association Response frames only when the DBE critical updates is being announced and TPE information needs to be provided for the DBE BW per regulatory or local rules. The TPE Wrapper Element 1000 provides complete TPE information for the entire DBE BW. In an alternative, the TPE Wrapper Element 1000 provides only the delta TPE information relative to the TPE elements carried in the Beacon frame for the BSS BW. The TPE Wrapper Element 1000 adds approximately 3 octets of overhead relative to providing TPE information with critical updates. Both mechanisms avoid modifying the existing TPE elements in the Beacon frame.

### Providing TPE Information for DBE BW in TPE Elements in the Beacon Frame

In another embodiment, when DBE mode is enabled or the DBE BW is updated, the TPE element(s) in Beacon frames, Probe Response frames, and (Re)Association Response frames are modified to also provide TPE information for the DBE BW. In this approach, the modified TPE element(s) are carried in Beacon frames for the entire duration during which DBE mode is enabled and are changed back to provide TPE information for the BSS BW only when DBE mode is disabled. Because the same TPE elements understood by legacy STAs are being modified, this approach raises potential legacy compatibility/interoperability issues, as frequent changes to TPE elements and the provision of TPE information for BWs greater than the BSS BW have not been tested with legacy STAs. Additionally, because the TPE information for the DBE BW is carried for the entire time DBE mode is enabled, this approach has a higher beacon bloating impact. Modifying the TPE elements in the Beacon also triggers critical update notifications that are visible to legacy STAs, which is undesirable because these updates are not intended for those legacy devices.

In a variation, the TPE information for the DBE BW is provided in the TPE element(s) in the Beacon frame and Probe Response frame only during the DBE critical updates announcement period. Once DBE mode is enabled or the DBE BW is updated, the TPE information in the Beacon frame and Probe Response frame is changed back to TPE for the BSS BW only. This variation reduces beacon bloating impact, but potential legacy compatibility/interoperability issues remain.

### Providing TPE Information for DBE BW Using the Existing TPE Element Fields

As a further alternative, in certain embodiments, the existing TPE element fields, including the Maximum Transmit Power field 410 and the Extension Maximum Transmit Power field 415, can be extended to also cover the DBE BW, without introducing a separate DBE TPE element or subelement.

For EIRP-based TPE elements (Maximum Transmit Power Interpretation subfield=0, 2, or 4), each BW has a separate, self-contained Maximum Transmit Power subfield (e.g., Maximum Transmit Power For 20 MHz, For 40 MHz, For 80 MHz, For 160/80+80 MHz). Legacy STAs operating over the BSS BW only look at the subfield corresponding to the BSS BW or smaller BWs and ignore additional subfields present for larger BWs. Accordingly, additional Maximum Transmit Power subfields covering the DBE BW can be added to EIRP-based TPE elements without impacting legacy STA behavior. For example, if the BSS BW is 40 MHz and the DBE BW is 160 MHz, the EIRP-based TPE element may include Maximum Transmit Power subfields for 20 MHz, 40 MHz, 80 MHz, and 160 MHz. Legacy STAs would look at the 20 MHz and 40 MHz subfields only, while DBE-supporting STAs would additionally use the 80 MHz and 160 MHz subfields. The Maximum Transmit Power subfields for the DBE BW may be added to the EIRP-based TPE elements under any one of the following timing options: (i) only when DBE mode is enabled, for the entire duration DBE mode is enabled; (ii) only during the DBE critical updates announcement period; or (iii) always in the Beacon frame, regardless of whether DBE mode is enabled. If the DBE BW exceeds 160 MHz (e.g., 320 MHz), the Extension Maximum Transmit Power field 415 provides the maximum transmit power for the DBE BW at 320 MHz.

For EIRP PSD-based TPE elements (Maximum Transmit Power Interpretation subfield=1, 3, or 5), the Maximum Transmit Power field 410 carries Maximum Transmit PSD subfields for each 20 MHz sub-channel within the BSS BW from lowest to highest frequency. Adding PSD subfields for the DBE BW to the same TPE element is more complex and raises greater legacy compatibility concerns, because legacy STAs may not expect additional PSD subfields beyond those corresponding to the BSS BW channels. In one embodiment, the EIRP PSD-based TPE element may be extended to also cover the DBE BW as follows: the Maximum Transmit PSD subfields 1 through M within the Maximum Transmit Power field 410 correspond to the 20 MHz sub-channels from lowest to highest frequency within the BSS BW, and the Maximum Transmit PSD subfields M+1 through N correspond to the 20 MHz sub-channels from lowest to highest frequency within the portion of the DBE BW that contains the Primary 20 MHz (P20) channel, excluding the 20 MHz sub-channels already covered by the BSS BW. The Maximum Transmit PSD subfields M+1 through N can cover the DBE BW up to 160 MHz. If the DBE BW exceeds 160 MHz, the Extension Maximum Transmit Power field 415 is included and provides Maximum Transmit PSD subfields corresponding to the 20 MHz sub-channels from lowest to highest frequency within the DBE BW not already covered by the Maximum Transmit Power field 410. As with EIRP-based TPE elements, the extended PSD subfields may be added only when DBE mode is enabled, only during the DBE critical updates announcement period, or always in the Beacon frame.

However, extending the EIRP PSD-based TPE elements in the Beacon frame to cover the DBE BW also triggers legacy critical update notifications (because the TPE element in the Beacon frame is being modified), which is undesirable as these updates are not intended for legacy devices. A hybrid approach is also possible, in which the EIRP-based TPE information for the DBE BW is included in the EIRP-based TPE elements in the Beacon frame and Probe Response frame (given lower legacy compatibility concerns), while the EIRP PSD-based TPE information for the DBE BW is not included in the EIRP PSD-based TPE elements in the Beacon frame, but is instead provided as part of DBE parameters using the mechanisms described above. However, this hybrid approach would require DBE-supporting STAs to obtain EIRP-based TPE information for the DBE BW from the Beacon frame and EIRP PSD-based TPE information for the DBE BW from the DBE parameters, which complicates client-side processing. For this reason, both the EIRP-based and EIRP PSD-based TPE information for the DBE BW may be included as part of the DBE parameters using the critical updates signaling or DBE TPE wrapper signaling, to simplify client processing.

The following examples illustrate providing TPE information with critical updates and providing TPE information using existing TPE fields for specific DBE deployment scenarios.

For a 160 MHz channel composed of eight 20 MHz sub-channels S0-S7, each representing 20 MHz with S0 being the lowest frequency. An AP operating as a 40 MHz BSS has a Primary 20 MHz (P20) at S6 (denoted P6), operating on P6+S7. The AP expands its DBE BW to 160 MHz, adding sub-channels S0-S5 to the expanded BW. The BSS BW is P6+S7={S0, S1, S2, S3, S4, S5, P6, S7} (40 MHz primary channel within 160 MHz primary channel BW), and the DBE BW spans S0-S7. When providing TPE information with critical updates, the DBE TPE element provides the maximum transmit power for the entire S0-S7 BW. When using existing fields, the regular TPE element provides maximum transmit power for P6 and S7 in the Maximum Transmit Power field 410, and provides maximum transmit power for either the full S0-S7 BW or only the additional sub-channels S0-S5 (excluding P6 and S7 already covered by the Maximum Transmit Power field 410) in the Extension Maximum Transmit Power field 415.

For a 320 MHz channel composed of sixteen 20 MHz sub-channels S0-S15 with S0 being the lowest frequency. An AP operating as a 40 MHz BSS has a P20 at S9 (denoted P9), operating on S8+S9. The AP expands its DBE BW to 320 MHz, adding sub-channels S0-S7 and S10-S15. The BSS BW spans S0-S15 with P9, and the DBE BW spans S0-S15. Under Option 4, the regular TPE element provides maximum transmit power for S8 and S9 in the Maximum Transmit Power field 410, and provides maximum transmit power for the full S0-S15 BW (or only the additional sub-channels, excluding S8 and S9) in the Extension Maximum Transmit Power field 415.

### Providing TPE Information in (Re)Association Response and Probe Response Frames

In one embodiment, a DBE-supporting AP provides TPE information for the DBE BW as part of the (Re)Association Response frame or Probe Response frame. Per the IEEE 802.11 baseline specification, Association Response frames and Reassociation Response frames do not carry TPE elements. Embodiments of the present disclosure extend the Association Response frame and Reassociation Response frame to optionally include one or more TPE elements to provide TPE information for the maximum supported DBE BW of the AP. If a DBE-supporting AP sends an Association Response frame or Reassociation Response frame to a UHR STA that also supports DBE, the AP may include one or more TPE elements to provide TPE information (applicable for the 6 GHz link) for the maximum supported DBE BW.

If the AP is an AP MLD, the AP can provide TPE information for the current link using one or more TPE elements included directly in the (Re)Association Response frame sent to a DBE-supporting UHR STA. For other accepted links indicated in the Basic ML element in the (Re)Association Response frame, the affiliated AP on that link can provide TPE information for that link, if applicable, for the maximum supported DBE BW on that link, by including one or more TPE elements in the STA Profile field of the Per-STA Profile subelement included for that link in the Basic ML element. In one case, inheritance is applied if the TPE element(s) for the maximum supported DBE BW are the same for the current link and another accepted link, in which case the STA Profile field in the Per-STA Profile subelement for that other link does not need to carry TPE elements.

For Probe Response frames, a DBE-supporting AP may include one or more TPE elements in the Probe Response frame to provide TPE information for the maximum supported DBE BW of the AP. For other links of an AP MLD, the STA Profile field in the Per-STA Profile subelement of the Basic ML element in the multi-link Probe Response frame provides TPE information for the maximum supported DBE BW of that link. In all of these cases, the TPE element(s) providing the maximum supported DBE BW information may provide the maximum transmit power information in the Extension Maximum Transmit Power field 415, in the Maximum Transmit Power field 410, or split across the two fields.

When a DBE mode is being enabled on an AP, if the TPE information for the DBE BW (or the maximum supported DBE BW) has been updated since the (Re)Association Response frame was sent to any associated STA, the updated TPE information for the DBE BW is provided in the DBE critical updates notification, by including the content of one or more TPE elements as subelements or fields in the DBE critical updates notification. On the other hand, if the TPE information for the DBE BW has not been updated since the last (Re)Association Response frame that was sent to any of the associated STAs, the DBE critical updates notification (for DBE mode enablement or for a DBE BW parameter update) does not need to include any TPE information for the DBE BW. In one case, the DBE TPE element(s) or fields in the DBE critical updates notification provide TPE information only for the DBE BW being enabled or the updated DBE BW. In another case, the DBE TPE element(s) or fields provide TPE information for the maximum supported DBE BW of the AP.

### Changes to TPE Information for DBE BW

After DBE mode is enabled, the TPE information for the DBE BW may change for regulatory reasons (e.g., due to an updated regulatory or local maximum transmit power limit). Such changes to the TPE information for the DBE BW are signaled as a DBE parameter critical updates using the UHR critical updates advance notification mechanism. Specifically, the Mode Update field 824 in the Mode Tuple for DBE is set to 1, and the updated TPE information for the DBE BW is included in the DBE critical updates notification as part of Mode specific parameters field 826 or providing TPE Information in a separate DBE TPE wrapper element (or providing TPE information in existing TPE elements of Beacon frames, less preferred). When providing updated TPE information for DBE bandwidth as part of DBE critical update announcement, one or more updated DBE TPE subelements are included in the Mode Specific Parameters field 826 for DBE in the UHR Parameters Update element 800.

Similarly, certain embodiments configure the AP to signal any TPE information updates applicable to the BSS BW as UHR critical updates. This enables any TPE information changes for the BSS BW to be signaled in advance (before the change takes effect) using the UHR advanced critical update mechanism, so that STAs can prepare to follow the updated maximum transmit power limits. The 11bn-defined UHR critical updates procedure is followed for signaling changes to TPE information for the BSS BW in Beacon frames, Probe Response frames, and (Re)Association Response frames. Such a change updates the enhanced BSS Parameters Change Counter (BPCC), increments the Update Counter for the UHR critical updates (in the Traffic Indication Map (TIM) element), sets the Enhanced Critical Update Flag in the Capabilities Information field, and sets the Enhanced All Updates Included (AUI) field, per the UHR-defined critical updates procedure.

### Client Behavior Related to TPE for DBE BW

When providing TPE information with DBE critical updates for DBE BW, DBE-supporting STAs plan for using the announced maximum transmit power from the TPE information from the DBE TPE element(s) or element(s) included in the DBE critical updates announcement for the upcoming DBE expanded BW. DBE-supporting STAs follow the current maximum transmit power using the TPE information from the current DBE TPE element(s) or element(s) included for the active DBE expanded BW.

When using existing TPE element fields, A non-AP MLD that is pre-UHR or that does not support DBE obtains the maximum transmit power information from the Maximum Transmit Power field 410 of the regular TPE element. The non-AP MLD ignores any additional Maximum Transmit PSD subfields included in the Maximum Transmit Power field 410 for the DBE BW. DBE-supporting STAs plan for using the announced maximum transmit power for the DBE expanded BW from the Maximum Transmit Power field 410 and/or the Extension Maximum Transmit Power field 415, based on the expanded DBE BW size and the specific approach used for populating these fields for the DBE BW. DBE-supporting STAs similarly follow the active maximum transmit power for the DBE expanded BW from the Maximum Transmit Power field 410 and/or the Extension Maximum Transmit Power field 415.

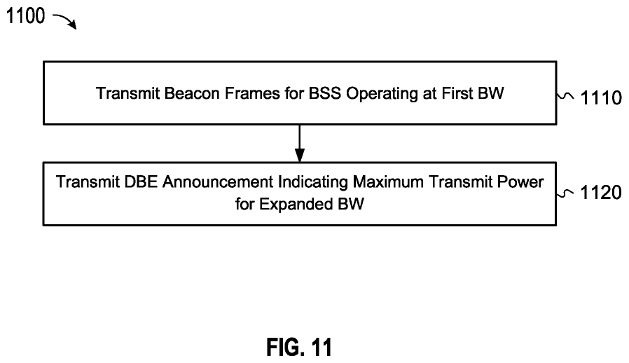

FIG. 11 is a flow diagram illustrating a method 1100 for transmit power indication and MCS and NSS parameters indication for DBE. Method 1100 may be performed by an AP (e.g., first AP 115, second AP 120, or third AP 125 of FIG. 1).

At stage 1110, the AP transmits beacon frames for a BSS operating at a first BW. The beacon frames include one or more TPE elements providing maximum transmit power information for operation over the first BW.

At stage 1120, the AP transmits a DBE announcement indicating a BW expansion for the BSS to operate at an expanded DBE BW greater than the first BW. The DBE announcement includes one or more DBE TPE elements providing maximum transmit power information for operation over the expanded DBE BW.

In some embodiments, the one or more DBE TPE elements are separate from the one or more TPE elements included in the beacon frames for the first BW, and the beacon frames continue to include the one or more TPE elements for the first BW without modification for the expanded DBE BW. This ensures that legacy STAs continue to receive unmodified TPE information for the BSS BW and are not impacted by the DBE TPE information.

In some embodiments, transmitting the DBE announcement at stage 1110 comprises transmitting a critical update announcement using a UHR Parameters Update element, and the one or more DBE TPE elements are included in the UHR Parameters Update element. In one embodiment, the one or more DBE TPE elements are included in the Mode Specific Parameters field for DBE within a Mode Tuple of the UHR Parameters Update element, as described above with respect to FIG. 8. The UHR Parameters Update element is included in one or more of a beacon frame, a probe response frame, or a (re)association response frame during an advance notification period before the expanded DBE BW takes effect.

In some embodiments, when the BSS is operating at the expanded DBE BW, the AP includes the one or more DBE TPE elements in a UHR Operation element included in probe response frames and (re)association response frames transmitted by the AP, as described above with respect to FIG. 7. In one embodiment, the DBE TPE elements are included in the DBE Operation Parameters field 710 of the UHR Operation element 700.

In some embodiments, the DBE announcement comprises a UHR Parameters Update element comprising an indicator set to indicate a presence of a DBE TPE Wrapper element. The DBE TPE Wrapper element comprises the one or more DBE TPE elements, as described above with respect to FIGS. 9 and 10.

In some embodiments, the AP transmits one or more management frames comprising supported MCS and NSS set information for one or more BWs supported for DBE operation. In some embodiments, the supported MCS and NSS set information is provided in a DBE-specific field, element, or subelement that is interpretable only by DBE-supporting STAs. The supported MCS and NSS set information is provided in a UHR Capabilities element in example implementations. In this way, the AP avoids advertising higher BW capabilities in legacy-visible capability fields, preventing legacy STAs from misinterpreting the AP's capabilities.

In some embodiments, the AP transmits one or more management frames comprising supported MCS and NSS set information for one or more BWs supported for DBE operation and a maximum supported BW for DBE operation. The expanded DBE BE is smaller than or equal to the maximum supported BW for DBE operation. In certain implementations, the maximum supported BW and the supported MCS and NSS set information are provided in a DBE-specific field, element, or subelement that is interpretable only by DBE supporting STAs. In example implementations, the maximum supported BW and the supported MCS and NSS set information are provided in a UHR Capabilities element in the one or more management frames.

In some embodiments, the method 1100 further comprises receiving, from a non-AP STA, an indication of the non-AP STA's maximum supported BW for DBE operation in existing BW capability fields. The existing BW capability fields may be defined for VHT, HE, or EHT in example implementations.

In additional embodiments not separately illustrated, method 1100 further comprises detecting a change to the maximum transmit power information for the expanded DBE BW while the expanded DBE BW is active, and transmitting an updated DBE critical update announcement including a Mode Update field set to indicate a DBE parameter update, with one or more updated DBE TPE elements providing the updated maximum transmit power information for the expanded DBE BW. In further embodiments, the AP signals any changes to maximum transmit power information for the first BSS BW using a UHR critical update procedure, comprising updating an enhanced BSS Parameters Change Counter, incrementing an Update Counter in a TIM element, setting an Enhanced Critical Update Flag in a Capabilities Information field, and setting an Enhanced All Updates Included field.

In additional embodiments, method 1100 further comprises including, in association response or reassociation response frames transmitted to DBE-supporting STAs, one or more TPE elements providing maximum transmit power information for a maximum supported DBE BW of the AP, and conditionally including updated TPE information for the expanded DBE BW in the DBE critical updates announcement when the maximum transmit power information for the expanded DBE BW has changed since those frames were transmitted. In still further embodiments, when the DBE announcement is included in beacon frames only for a finite advance notification period, the AP includes the one or more DBE TPE elements in a probe response frame transmitted in response to a probe request from a STA that did not receive the DBE announcement from the beacon frames.

FIG. 12 is a block diagram of a computing device 1200. As shown in FIG. 12, computing device 1200 may include a processing unit 1210 and a memory unit 1215. Memory unit 1215 may include a software module 1220 and a database 1225. While executing on processing unit 1210, software module 1220 may perform, for example, processes for providing transmit power indication and MCS and NSS parameters indication for DBE. Computing device 1200, for example, may provide an operating environment for the controller 105, the first AP 115, the second AP 120, the third AP 125, the first client device 130, the second client device 135, the third client device 140, and the like. The controller 105, the first AP 115, the second AP 120, the third AP 125, the first client device 130, the second client device 135, the third client device 140, and the like may operate in other environments and are not limited to computing device 1200.

Computing device 1200 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1200 may comprise any computer operating environment, such as hand-held devices, multiprocessor systems, microprocessor-based or programmable sender electronic devices, minicomputers, mainframe computers, and the like. Computing device 1200 may also be practiced in distributed computing environments where tasks are performed by remote processing devices. The aforementioned systems and devices are examples, and computing device 1200 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 1200 on the single integrated circuit (chip).

FIG. 13 illustrates an implementation of a communications device 1300 that may implement one or more of the controller 105, the first AP 115, the second AP 120, the third AP 125, the first client device 130, the second client device 135, the third client device 140, etc. In various implementations, the communications device 1300 may comprise a logic circuit. The logic circuit may include physical circuits to perform operations described for one or more of the controller 105, the first AP 115, the second AP 120, the third AP 125, the first client device 130, the second client device 135, the third client device 140, etc., for example. As shown in FIG. 13, the communications device 1300 may include one or more of, but is not limited to, a radio interface 1310, baseband circuitry 1330, and/or the computing device 1200.

The communications device 1300 may implement some or all of the structures and/or operations for the controller 105, the first AP 115, the second AP 120, the third AP 125, the first client device 130, the second client device 135, the third client device 140, etc., storage medium, and logic circuit in a single computing entity, such as entirely within a single device. Alternatively, the communications device 1300 may distribute portions of the structure and/or operations using a distributed system architecture, such as a client station server architecture, a peer-to-peer architecture, a master-slave architecture, etc.

A radio interface 1310, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1310 may include, for example, a receiver 1315 and/or a transmitter 1320. The radio interface 1310 may include bias controls, a crystal oscillator, and/or one or more antennas 1325. In additional or alternative configurations, the radio interface 1310 may use oscillators and/or one or more filters, as desired.

The baseband circuitry 1330 may communicate with the radio interface 1310 to process, receive, and/or transmit signals and may include, for example, an Analog-To-Digital Converter (ADC) for down converting received signals with a Digital-To-Analog Converter (DAC) 1335 for up converting signals for transmission. Further, the baseband circuitry 1330 may include a baseband or Physical (PHY) layer processing circuit for the PHY link layer processing of respective receive/transmit signals. Baseband circuitry 1330 may include, for example, a Media Access Control (MAC) processing circuit 1340 for MAC/data link layer processing. Baseband circuitry 1330 may include a memory controller for communicating with MAC processing circuit 1340 and/or a computing device 1200, for example, via one or more interfaces 1345.

In some configurations, PHY processing circuit may include a frame construction and/or detection module, in combination with additional circuitry such as a buffer memory, to construct and/or deconstruct communication frames. Alternatively or in addition, MAC processing circuit 1340 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
transmitting, by an access point (AP), beacon frames for a basic service set (BSS) operating at a first bandwidth (BW), the beacon frames including one or more transmit power envelope (TPE) elements providing maximum transmit power information for operation over the first BW; and
transmitting, by the AP, a dynamic bandwidth expansion (DBE) announcement indicating a BW expansion for the BSS to operate at an expanded DBE BW greater than the first BW;
wherein the DBE announcement comprises one or more DBE TPE elements providing maximum transmit power information for operation over the expanded DBE BW.

2. The method of claim 1, wherein:
the one or more DBE TPE elements are separate from the one or more TPE elements included in the beacon frames for the first BW, and
the beacon frames continue to include the one or more TPE elements for the first BW without modification for the expanded DBE BW.

3. The method of claim 1, wherein:
transmitting the DBE announcement comprises transmitting a critical update announcement using an ultra high reliability (UHR) parameters update element, and
the one or more DBE TPE elements are in the UHR parameters update element.

4. The method of claim 1, further comprising:
when the BSS is operating at the expanded DBE BW, including the one or more DBE TPE elements in a UHR Operation element included in probe response frames and (re)association response frames transmitted by the AP.

5. The method of claim 1, further comprising:
transmitting one or more management frames comprising supported modulation and coding scheme (MCS) and number of spatial streams (NSS) set information for one or more BWs supported for DBE operation.

6. The method of claim 5, wherein:
the one or more management frames further comprise a maximum supported BW for DBE operation; and
the expanded DBE BW is smaller than or equal to the maximum supported BW for DBE operation.

7. The method of claim 6, wherein the maximum supported BW and the supported MCS and NSS set information are provided in a DBE-specific field, element, or subelement that is interpretable only by DBE supporting STAs.

8. The method of claim 6, wherein the maximum supported BW and the supported MCS and NSS set information are provided in a UHR Capabilities element in the one or more management frames.

9. A system comprising:
a memory storage; and
a processing unit coupled to the memory storage, wherein the processing unit is operative to:
transmit beacon frames for a basic service set (BSS) operating at a first bandwidth (BW), the beacon frames including one or more transmit power envelope (TPE) elements providing maximum transmit power information for operation over the first BW; and
transmit a dynamic bandwidth expansion (DBE) announcement indicating a BW expansion for the BSS to operate at an expanded DBE BW greater than the first BW;
wherein the DBE announcement comprises one or more DBE TPE elements providing maximum transmit power information for operation over the expanded DBE BW.

10. The system of claim 9, wherein:
the one or more DBE TPE elements are separate from the one or more TPE elements included in the beacon frames for the first BW, and
the beacon frames continue to include the one or more TPE elements for the first BW without modification for the expanded DBE BW.

11. The system of claim 9, wherein:
to transmit the DBE announcement comprises to transmit a critical update announcement using an ultra high reliability (UHR) parameters update element, and
the one or more DBE TPE elements are in the UHR parameters update element.

12. The system of claim 9, wherein the processing unit is further operative to:
when the BSS is operating at the expanded DBE BW, include the one or more DBE TPE elements in a UHR Operation element included in probe response frames and (re)association response frames transmitted by the AP.

13. The system of claim 9, wherein the processing unit is further operative to:
transmit one or more management frames comprising supported modulation and coding scheme (MCS) and number of spatial streams (NSS) set information for one or more BWs supported for DBE operation.

14. The system of claim 13, wherein:
the one or more management frames further comprise a maximum supported BW for DBE operation; and
the expanded DBE BW is smaller than or equal to the maximum supported BW for DBE operation.

15. The system of claim 14, wherein the maximum supported BW and the supported MCS and NSS set information are provided in a UHR Capabilities element in the one or more management frames.

16. A non-transitory computer-readable medium that stores a set of instructions which, when executed by a processing unit, cause the processing unit to perform a method comprising:
transmitting beacon frames for a basic service set (BSS) operating at a first bandwidth (BW), the beacon frames including one or more transmit power envelope (TPE) elements providing maximum transmit power information for operation over the first BW; and
transmitting a dynamic bandwidth expansion (DBE) announcement indicating a BW expansion for the BSS to operate at an expanded DBE BW greater than the first BW;
wherein the DBE announcement comprises one or more DBE TPE elements providing maximum transmit power information for operation over the expanded DBE BW.

17. The non-transitory computer-readable medium of claim 16, wherein:
the one or more DBE TPE elements are separate from the one or more TPE elements included in the beacon frames for the first BW, and
the beacon frames continue to include the one or more TPE elements for the first BW without modification for the expanded DBE BW.

18. The non-transitory computer-readable medium of claim 16, wherein:
transmitting the DBE announcement comprises transmitting a critical update announcement using an ultra high reliability (UHR) parameters update element, and
the one or more DBE TPE elements are in the UHR parameters update element.

19. The non-transitory computer-readable medium of claim 16, the method executed by the set of instructions further comprising:
when the BSS is operating at the expanded DBE BW, including the one or more DBE TPE elements in a UHR Operation element included in probe response frames and (re)association response frames transmitted by the AP.

20. The non-transitory computer-readable medium of claim 16, the method executed by the set of instructions further comprising:
transmitting one or more management frames comprising supported modulation and coding scheme (MCS) and number of spatial streams (NSS) set information for one or more BWs supported for DBE operation.
